(19) United States
(12) Patent Application Publication
(10) Pub. No.: US 2009/0060458 A1
(43) Pub. Date: Mar. 5, 2009

(54) METHOD FOR SYNCHRONIZING DATA FLOWS

(76) Inventors: Frederic Bauchot, Saint-Jeannet (FR); Gerard Marmigere, Drap (FR); Daniel Mauduit, Nice (FR); Michel Porta, Cagnes-sur-mer (FR)

Correspondence Address: HOFFMAN WARNICK LLC, 75 STATE ST, 14 FL, ALBANY, NY, 12207, US

(21) Appl. No.: 12/199,865

(22) Filed: Aug. 28, 2008

(30) Foreign Application Priority Data
Aug. 31, 2007 (EP) 07301334.4

(51) Int. Cl. H04N 5/95

(52) U.S. Cl. 386/102; 386/E05.037

(57) ABSTRACT

The first data flow is buffered at a receiver, and the buffer contents are scanned for metadata. Where metadata are found indicating a second data flow which has not yet arrived, the system enters a stalling phase during which the length of any silent periods in the first data flow are stretched. As the point in the first data flow at which the second data flow is necessary gets closer, the factor by which silent periods are stretched increases exponentially. Once the expected second data flow in fact arrives, playback of two data flows is accelerated by compressing silent periods so as to clear the backlog of additional data that built up in the buffer during the stalling phase.

### FIELD OF THE INVENTION

The present invention relates generally to data processing, and more particularly to systems and methods for synchronizing data flows (e.g., audio, image, video, or computer programs).

### BACKGROUND OF THE INVENTION

Thanks to increased bandwidth, storage, and computing capacities, users of computer programs tend to produce and consume more and more multimedia content. Sometimes called rich media environments, these environments are characterized by the use of a plurality of media, each of a different nature. This content can be, for example, slides of a presentation, images, videos, animations, graphics, maps, web pages, or any other media objects (animated or not), even including executable programs and their resulting display. The final resulting data flow that is displayed to the user can thus be comprised of a plurality of media objects. It is observed that any of these objects may be synchronized with another and the relationships between objects can change over time.

These media objects are delivered by various means. This content can be streamed, and can often be retrieved using a progressive download mode or even completely downloaded in advance. Indeed, in most cases, a plurality of networks can be used, even for any one single content, for these modes of delivery. It appears that uncontrolled network delays can imply a de-synchronization between the different flows and result in an imperfect or not displayable final data flow. As concerns the quality of service, on the Internet, one can not guarantee the delivery of service over time. The situation is even worse when a plurality of networks are used. Consequently, there is a need for means for synchronizing all these data flows.

The state of the art describes several techniques to remedy these de-synchronizations. Many approaches relate simply to specific methods for generating the synchronization information itself. Other approaches focus on buffering mechanisms, in order to counterbalance the uncertainty of network traffics and their congestions or bottlenecks. Indeed, a classic approach is to use a buffer, to get enough data to be displayed. When used in a streaming environment for example, predetermined thresholds require absolute (in megabytes) or relative (percentage of the file size) amount of data to be received and accumulated before beginning the playback of the file in a media player. The setting-up of these thresholds can use different techniques (statistics, rules-based, etc.). Mechanisms attempting to dynamically predict network delays and by accordingly adapting the buffer's depth can also be used. While media streaming makes use of such buffer mechanisms, another widely used approach is known as progressive download. The file is classically downloaded but the playback of the file can begin as soon as data is received; in this case, there is no buffer anymore in the classical sense.

Other approaches focus on the synchronization or re-synchronization of audio data flow (or stream) with their associated video stream, mainly by buffer adjustments and compensations. For example, U.S. Pat. No. 6,262,776 filed by Laurence Kelvin Griffits, and entitled “System and method for maintaining synchronization between audio and video” describes a system and method that selectively drops frames of video data in order to help maintain synchronization between the audio data and the video data. The main problem with this approach is that it only addresses synchronization between audio and video, and not other kind of flows.

Likewise, U.S. Patent application 2007/0019931A1, filed by Sirbu, Mihai G., and entitled “Systems and methods for re-synchronizing video and audio data” relates to systems and methods for re-synchronizing video and audio data. The systems and methods compare a video count associated with a video jitter buffer with a predefined video count. A given audio silence period in audio data associated with an audio jitter buffer is adjusted in response to the video count of the video jitter buffer being outside a predetermined amount of the predefined video count, until the video count is within the predetermined amount of the predefined video count. The main problem is the same as with the preceding patent: it only addresses synchronization between audio and video, and not other kind of flows.

In so described complex media environments, involving multiple contents and networks, there is no means for synchronizing various incoming data flows.

### SUMMARY OF THE INVENTION

A user of a media player software program is able to watch many videos at one moment, while the equivalent is difficult if not impossible with sounds. Audio is thus key to synchronization, which must be audio-driven. Accordingly, there is a need for a method using this particular property of human perception capabilities, in particular leveraging the use of audio silence periods.

According to a first aspect of the present invention, there is provided a method for synchronizing data flows in a buffer. While receiving a first data flow comprising audio data, as soon as a synchronization mark, associating first data of the first data flow with second data of a second data flow is received, at least one audio silence period is detected in the first data flow. If the synchronization mark is received before receipt of the associated second data of the second data flow, the first data flow is modified within the buffer by increasing the duration of the at least one audio silence period.

According to a second aspect of the present invention, there is provided an apparatus comprising means adapted for carrying out each step of the method according to the first aspect of the invention.

According to a third aspect of the present invention, there is provided a computer-liked readable medium comprising instructions for carrying-out each step of the method and/or apparatus according to the first or second aspect of the invention.

Further features of the present invention will become clear to the skilled person upon examination of the drawings and detailed description. It is intended that any advantages be incorporated herein.

### BRIEF DESCRIPTION OF THE DRAWINGS

Embodiments of the present invention will now be described with reference to the following drawings.

FIG. 1 shows the global environment of the invention.

FIG. 2 shows a block diagram describing the synchronization unit, at which level the invention operates.

FIG. 3 shows a flow chart describing the method.

FIG. 4 illustrates a data flow, audio silence periods, the buffer and a synchronization mark.

FIG. 5 illustrates the compensation of consequent operations of increasing and decreasing durations of audio silence periods.

FIG. 6 illustrates the case wherein the second data flow is never retrieved;

FIG. 7 shows an implementation of the invention wherein the first data flow is an audio/video data flow.

FIG. 8 shows the detection of audio silence periods.

FIG. 9 shows measurements aspects for the audio silence periods detection.

### DETAILED DESCRIPTION OF THE INVENTION

Data flow may correspond to data transmitted by networks, such as images (pictures, maps, or any graphics data, etc.), texts (emails, presentations slides, chat sessions, deposition transcripts, web pages, quizzes, etc.), videos (animated images, sequence of frames, webcam videos, TV programs, etc. ), multimedia documents (rich media documents, etc.) or even program data (3D animations, games, etc.) In most cases, the expression data flow is equivalent to data stream.

Audio silence periods refer to parts of a soundtrack or to sounds which can be characterized as calm, quiet, peaceful, or even mute or noiseless, for example. Silence is a relative concept to which objective measures are obvious to a skilled person (low pass filter, gain, etc.).

Synchronization is an object of this application and can apply to various situations. A non-exhaustive list comprises the types (examples in parenthesis): audio with text (MP3 song with lyrics transcript), audio with audio (MP3 mixing or phone conversations multiplexing), audio with image (MP3 and album jacket image), audio with video (podcast and video of the speaker), audio-video with text (music clip and lyrics), audio-video and audio (movie and additional musical soundtrack), audio-video and image (videocast and slides or graphics or maps or any other of adjacent document), audio-video with video (videocast and flash animation), audio-video with program (videocast and interactive animation) or even audio-video with audio-video (synchronization of two videos for arts, video walls, video editing, etc.). It is observed that two videos may be synchronized with the present invention, having opposite silent and non-silent periods. Most of the time, synchronization applies to rich media objects. Rich media is the term used to describe a broad range of interactive digital media that exhibit dynamic motion, taking advantage of enhanced sensory features such as video, audio and animation. This motion may occur over time (stock ticker continually updating for example) or in direct response to user interaction (webcast synchronized with slideshow that allows user control). A so called rich media file can be considered as a gathering of synchronized and non-synchronized data flows.

Buffers are used to accumulate data in order to avoid freezes due to network delays, which cannot be controlled. Buffer depth (or length) is usually sized to anticipate these delays and to handle device constraints. In most cases, the buffer is sized to accommodate predicted network delays. In networks having very predictable behaviors, the buffer can be small. To the contrary (for example on the Internet, or in the context of loosely coupled systems, or any other networks without Quality of Service mechanisms (QoS)), networks delays can vary in a broad range and the size of the buffer needs to be more important. In the present invention, the size of the buffer does not matter. Even if the buffer has variable depth over time, it can be considered that the implementation of the claimed technical mechanism remains unchanged. Thus, it is considered in the drawings that the buffer has a fixed size. What's more, this case corresponds to the reality of many systems incorporating a buffer today. It is observed that while buffers can be implemented either in hardware or in software, the vast majority of buffers today are software-implemented. Buffers are usually used in a FIFO (first in, first out) method, outputting data in the order it came in. Lastly, it is observed that caches or data caching mechanisms can reach the same functionality as buffers (in most cases, caches store data in location with faster access, such as RAM).

To facilitate description, any numeral identifying an element in one figure will represent the same element in any other figure.

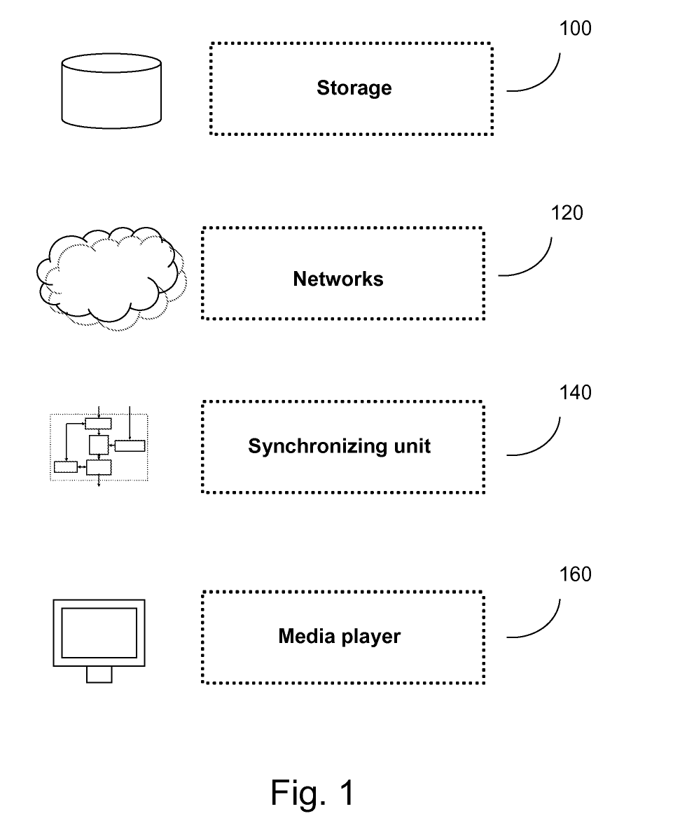

FIG. 1 depicts the global environment of the invention. As shown, there is provided a storage means (100) of data, a networks environment (120) through which data flows are transmitted, a synchronizing unit (140) at which level the present invention operates, and a media player (160) used for interpreting synchronized data flows.

Storage means (100) are used to store the data on a plurality of servers. These components can be encrypted or DRM protected, all or in part. Data caching mechanisms can also be used to accelerate the delivery of content. In particular, it is observed that a single component can be fragmented or distributed over a plurality of servers. All data flows are requested and transmitted through different networks (120) to the synchronizing unit (140). After synchronization, data flows are sent to the media player (160), comprising means for interpreting data flows (audio playback or video display, for example).

It is observed that stored data can be streamed but in some cases, FTP transfers or other ways of transmitting data can also be used. In particular, the transmission of data can occur either by streaming or by progressive download. Both ways do need buffering mechanisms. But while the streaming way requests only the frames to be displayed (according to the play cursor of the video), the progressive download way consists in starting to download the data file and immediately allowing to view already downloaded data. It is also observed that while a unique network can be used, a plurality of networks is more likely to be used. The networks can be of different nature and can be dynamically changed. For example, a component can first be requested and partly transmitted through a GSM network and when available the remaining part of the file be requested through a WIFI network. All kinds of networks can thus be employed, such as fiber (optic and others), cable (ADSL and others), wireless (Wifi, Wimax, and others) with a variety of protocols (FTP, UDP streaming and others).

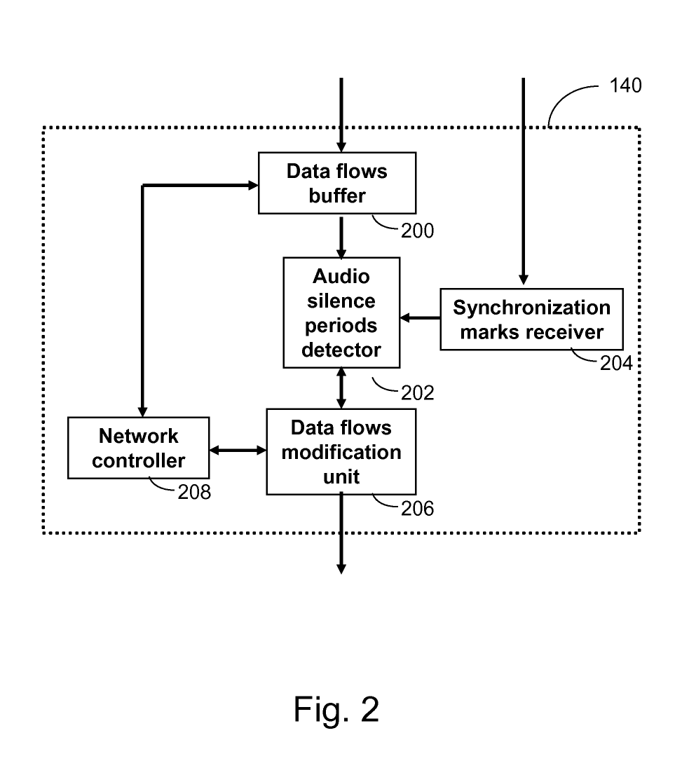

FIG. 2 shows a block diagram describing the synchronization unit 140, at which level the invention operates. The synchronization unit comprises a data flows buffer (200), an audio silence periods detector (202), a synchronization marks receiver (204), a data flows modification unit (206), and a network controller (208).

The data flows buffer (200) receives data transmitted by the networks (120). It is adapted to buffer a plurality of data flows and to send buffered data to the audio silence periods detector (202). The audio silence detector (202) is adapted for detecting audio silence periods in one or a plurality of data flows. It is connected to the synchronization marks receiver (204) and coupled to the data flows modification unit (206). The synchronization marks receiver (204) listens to the networks (120) for receiving one or a plurality of synchronization marks. It is connected to the audio silence periods detector (202). The data flows modification unit (206) interacts with the audio silence periods detector (202) and is also optionally coupled with the network controller (208). The data flows modification unit (206) is adapted to modify received data flows by increasing or decreasing audio silence periods. The network controller (208) interacts with the data flows buffer (200) and the data flows modification unit (206). The network controller (208) is adapted to measure network delays from the data flows buffer (200) and to control the data flows modification unit (206).

In an embodiment, the data flows buffer (200) buffers a first incoming data flow. As soon as the synchronization marks receiver (200) receives a synchronization mark involving the first data flow, the audio silence detector (200) starts analyzing and detecting audio silence periods. Meanwhile, the data flows buffer (200) listens for the pending necessary second data flow, as determined by the synchronization mark. Buffered data is modified in the data flows modification unit (200). Audio silence periods durations are increased or decreased, according to the interaction with the network controller (208). When both the second data of the second data flow to be synchronized with the first data of the first data flow and the first data of the first data flow are received, buffered, and synchronized, the data quit the buffer running positions for playing back in the media player (160).

The network controller (208) is optional (the synchronization can work without the network controller (208); interactions of the network controller (208) with both the data flows buffer (200) and the data flows modification unit (206) help improve performance of the invention. It is observed that the network controller (208) can be connected to others means adapted to measure network delays (not shown on the present figure) and not only from the data flows buffer (200). At last, the data flows modification unit (206) is adapted to be controlled by such controller (if delays are important, modifications will be important for example).

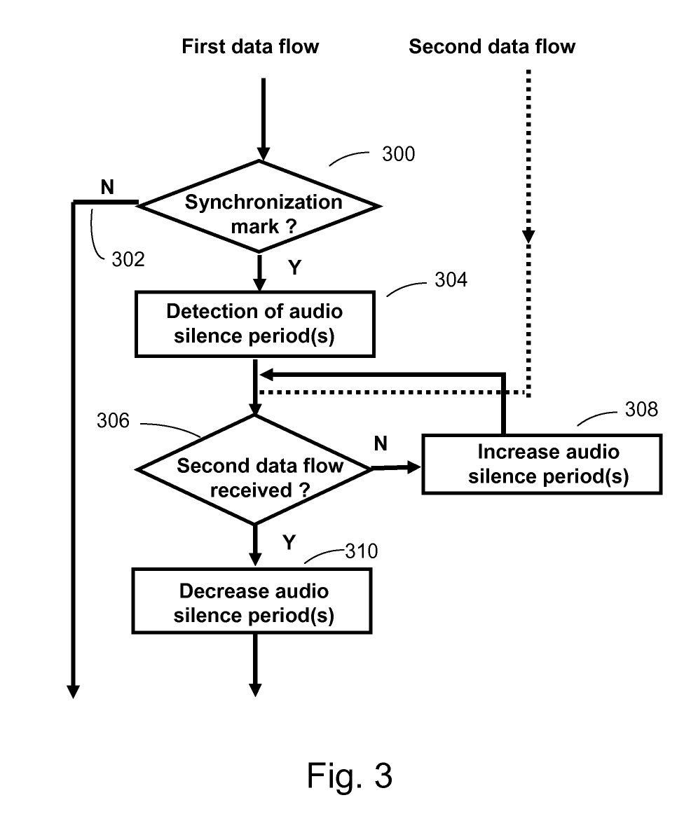

FIG. 3 shows a flow chart describing the method. As shown, there is a first data flow with a first data synchronized with a second data of a second data flow. The process includes:

a step (300) for receiving a synchronization mark between the first data of the first data flow and the second data of the second data flow;

a step (302) for normally buffering the first data flow in absence of a synchronization mark and playing it back;

a step (304) for detecting one or a plurality of audio silence periods;

a step (306) for establishing if second data of the second data flow is received;

a step (308) for increasing one or a plurality of durations of detected audio silence periods; and

a step (310) for decreasing one or a plurality of durations of detected audio silence periods.

A first data flow, which corresponding file is stored on a server or a plurality of storage servers (100) and which is transmitted through one or a plurality of networks (120), is received at the synchronization unit (140) of the media player (103). As soon as a synchronization mark between first data in the first data flow and second data of a second pending data flow is received at step (300), audio silence periods are being detected at step (304). Otherwise, the first data flow is buffered and played back normally, corresponding to the step (302). The detection of silence periods is continued until the second data of the second data flow (to be synchronized with the first data of the first data flow) is received in the buffer at step (306). While the second data flow is pending, the duration of one or a plurality of detected audio silence periods of the buffered first data flow is increased at step (308). When data of the second data flow comprising the second data to be synchronized is received in the synchronization unit (140), the duration of one or a plurality of detected audio silence periods of the buffered first data flow is decreased at step (310). Until the storage limit of the buffer is reached, data flows continue to be buffered. Then, synchronized data flows quit the buffer running positions for playing back in the media player (160).

It is observed that the synchronization mark can be embedded (in meta data for example) in the first data flow but not necessarily. Indeed, synchronization marks can be based on timecodes and then be received by one or many independent other channels. For example, in the case of a real-time webcast comprising the video of a speaker streamed from a first source synchronized with a slideshow coming from a second source, synchronization marks can make use of a third source (or network). These synchronization marks can be requested on demand (for example sent by the speaker himself) in the case of a live event. In most cases, such synchronization marks enclose the URL of a web page and a time value. They also can be enclosed in cookies in a browser environment.

It can also be observed that the second data flow can be simply received (because the sending is impulsed by an external and independent server) or requested by the embedded metadata (in either the first data flow or even in the synchronization mark itself for example).

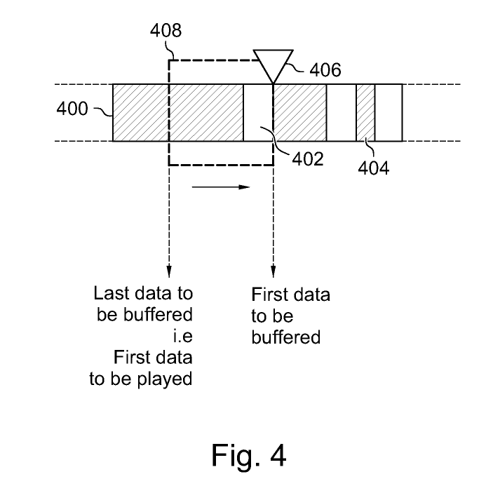

FIG. 4 illustrates a data flow, audio silence periods, the buffer and a synchronization mark. As shown in FIG. 4, there is provided:

a data flow (400);

an audio silence period (402) marked white;

a non-silent audio period (404) marked black;

a synchronization mark (406); and

a representation of a buffer (408).

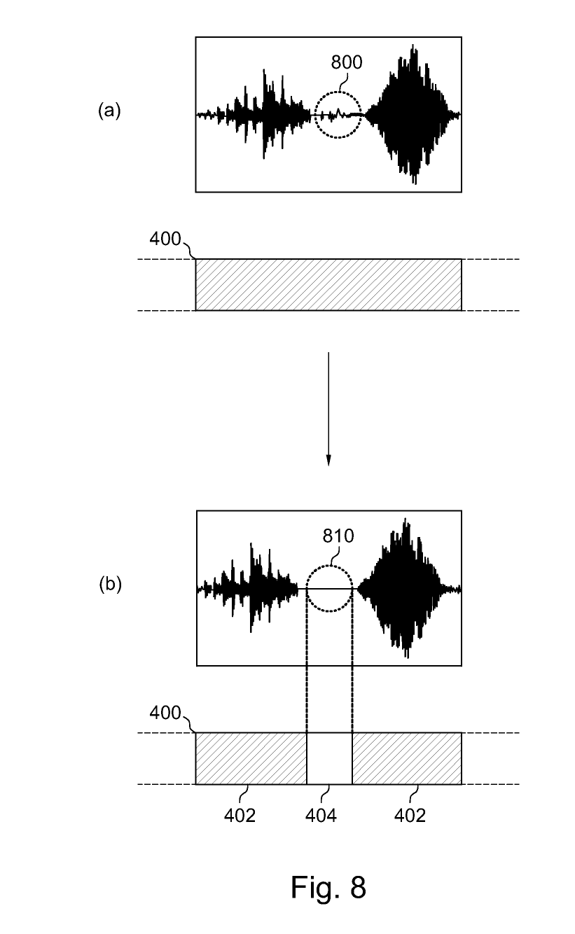

A data flow (400) is received, comprising audio silence periods (402) and non-silent audio periods (404); the detection of these periods is described more in details with respect with FIG. 8.

The buffer is represented at block (408), in dotted lines. The left side of the buffer (408) corresponds to the memory limit of the buffer, that is to say the point where data is released from the buffer for playing back. The right side of the buffer (408) corresponds to the entry of the buffer. As data is buffered, the buffer (408) running positions moves from left to the right on the drawing.

A synchronization mark (406) is received at a particular moment. This synchronization mark indicates that particular data of the data flow has to be synchronized with other particular data of another data flow (not represented).

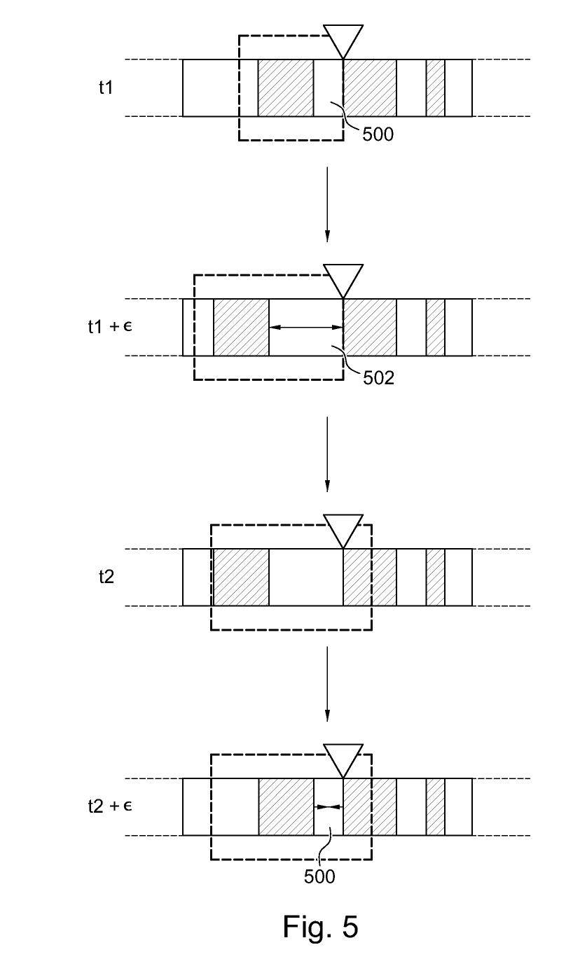

FIG. 5 illustrates the compensation of consequent operations of increasing and decreasing durations of audio silence periods.

As shown in FIG. 5, there is provided the same representation as in FIG. 4, with the additional elements:

an audio silence period (500) marked white;

a modified audio silence period (502) marked white; and

ε corresponds to a very short period of time for processing tasks.

At time t1, a synchronization mark is received. This synchronization mark calls for a second data of a second data flow to be synchronized with a particular data of the present data flow. An audio silence period (500) is detected. At time t1 plus ε, the duration of the audio silence period is increased a first time, resulting in a modified audio silence period (502). At time t2, necessary data of the second data flow is received. Accordingly, at time t2 plus ε, the duration of the modified audio silence period (502) is modified again, by decrement, resulting in exactly the previous duration (500). Consequent described operations thus result in a zero-sum operation.

In this drawing, a unique audio silence is shown and modified, for the sake of clarity. It is observed that a similar compensation can be obtained using a plurality of audio silence periods, if any. Some durations of these periods can be increased and then other be decreased so that the final result is an unchanged total duration. The compensation can be exact or not. This is another aspect of the invention to minimize the modifications brought to the data flows.

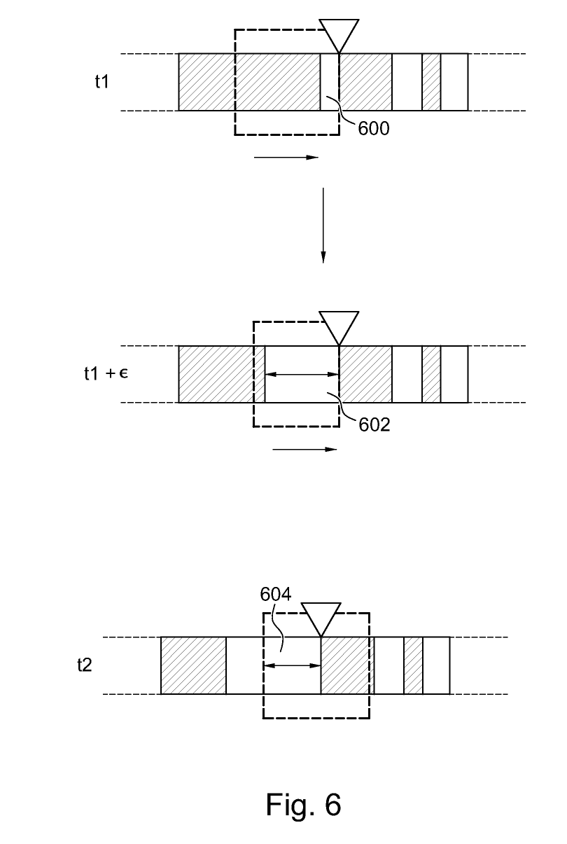

FIG. 6 illustrates the case wherein the second data flow is never retrieved.

The previous figure corresponded to the case in which needed data are received on time; the present figure illustrates the opposite situation, wherein needed (necessary) data is never received. As shown in FIG. 6, there is provided the same representation as in FIG. 4, with the additional elements:

an audio silence period (600) marked white;

a modified audio silence period (602) marked white;

a re-modified audio silence period (604) marked white; and

ε corresponds to a very short period of time for processing tasks.

Like the previous figure, at time t1, a synchronization mark is received. The duration of the unique silence period (600) is increased at time t1 plus ε, resulting in a modified audio silence period (602). At time t2, since necessary data has not been received, the duration is increased again. Incoming first data flow continues to be buffered: the buffer moves from left to right on the drawing. Silence is playing back (left side of the illustrated buffer). And the process continues accordingly (604). In other words, audio silence is exponentially increased.

At last it is observed that, like in the previous figure, a unique audio silence is shown and modified for the sake of clarity. The same mechanisms would be observed in presence of a plurality of audio silence periods, except that the implementation of the method could benefit from the choice of what period to increase. In an embodiment, the lastly received audio silence period (in other words the last buffered audio silence period; see FIG. 4, as shown with respect to the left side of the illustrated buffer) is increased. The increase model can thus follow any mathematical function (linear, constant, exponential, etc).

An advantage of this development is that it indirectly enables a delivery control. The playing back of synchronized flows will not be possible if necessary data is not received (audio silence or silences will be increased until the second data of the second data flow is received. If this second data of the second data flow is never received, the first data flow, due to the limit in size of the buffer, will seem frozen). Such controls can be very valuable for protecting contents. If the second data of the second data flow is attached with DRM (Digital Rights Management) rights and is not received within buffer (retrieved and properly decoded, for example), it will impede the restitution of the first data flow. The robustness of such a protection will also benefit from the use of a high number of similar necessary data flows.

To remedy the consequences of this scenario wherein necessary data is never received, a time-out mechanism can be used. This time-out may use a predetermined delay or it may be dynamically set up. It is observed that either the server or servers (sending data), the client (the media player with corresponding rules), the user (who might be able to command the drop of the retrieval of the synchronized flow) or even the first data flow itself (with embedded data) can comprise or impulse such time-out mechanism.

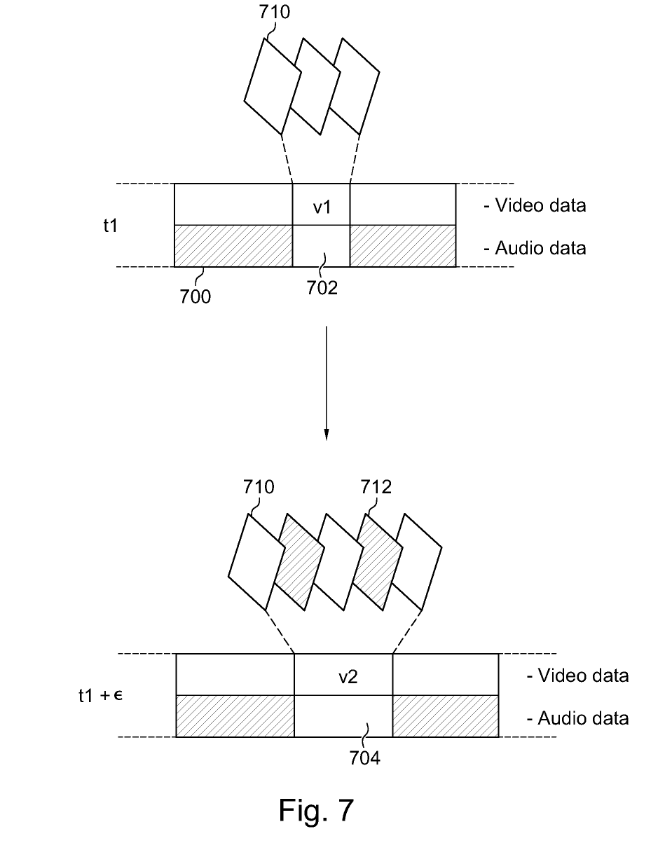

FIG. 7 shows an implementation of the invention wherein the first data flow is an audio/video data flow.

As shown in FIG. 7, there is provided:

a non-silent audio silence period (700);

a audio silence period (702);

a modified audio silence period (704);

a frame of the video data (710); and

an inserted additional video frame (712).

FIG. 6 shows a data flow comprising audio data and video data. The audio data comprises audio silence periods (702) and non-silent audio silence periods (700). The video data further comprises a plurality of sequential video frames (710), each frame being associated with particular audio data belonging to the first data flow. The data flow is referred to an audio/video data flow. At time t1 plus ε, the duration of the audio silence period (702) is increased resulting in a modified audio silence period (704). The corresponding video data (to this modified audio data) is modified by inserting additional video frames like (712) among any video frames associated with the audio data belonging to the audio silence period.

The present drawing indeed shows what happens when the duration of audio silence period is increased. The visual effect (if the modified data flow happens to be played back) is a slow-down or a freeze-up of the video during its audio silence periods.

For the opposite step (not shown in the drawings), wherein audio silence period is decreased (for example when necessary data is received or for compensating previous modifications), previously inserted frames are deleted or omitted; in some other cases, the visual effect, when playing back modified data will be a slow-down or even a freeze in the video replay.

All remarks related to aspects of the invention as described and shown with respect with previous figures thus similarly do apply (compensation, use of a plurality of audio silence periods, time-out mechanism, etc). In particular, FIG. 5 will see compensation between inserted and deleted frames within the buffer and there will likely be no visual impact during replay (playing back). FIG. 6 will see a freeze in the video replay (unless a time-out mechanism is used).

It is observed that there is a wide choice to insert additional video frames. For example, these frames can be duplicated frames (chosen among existing buffered frames for example) or even interpolated frames (in other words, generated frames). In order to have the lowest visual impact, the analysis of the video can help deciding the distribution of additional frames, both in regard to the nature of the frames to insert and to the periods at which to insert these video frames. The analysis can be processed on-the-fly (in the buffer for example) or predetermined (embedded in meta data to help this decision step). A scene characterized by a high bitrate (action scene with few if no audio silence periods for example) will less likely be usable than a lower bitrate scene (television speaker with audio silences periods in its speech for example). Thus, the analysis of the buffered data can help in deciding the best silent periods to insert video frames. These additional frames can be distributed over the plurality of available audio silence periods (equally distributed or not, even over on one unique audio silence period).

The present invention minimizes the global modifications brought to the data in the buffer so as to minimize the impact to final output. The distribution over several periods of silence can present an interest in this case. It is observed that buffer data modifications during audio silences can be driven by many other factors. Among the plurality of audio silences, there might be others factors to be taken into account, in order to decide which silence periods have preferably to be stretched. One of them is the minimization of corresponding video data modifications. For example, in a video sequence showing a speaker standing still introducing a documentary starting with an action scene like an explosion, it might be much more interesting to stretch audio silences of the speaker part than those, if any, of the action scene.

Many implementations are possible. A variety of different algorithms can be chosen to get a compromise between the need of gaining time for the retrieval of the second data flow and the need of having the less impact as possible on data to be outputted (compensations of previously made modifications). All algorithms have to take into account the time left, it means the time remaining in the buffer before the synchronization mark reaches the maximal size of the buffer, corresponding to the moment where the two synchronized data flows will actually need to be played out. A simple possibility consists in setting-up a threshold corresponding to the time left in the buffer before playing back. If there is a pending object (a second data flow to be received) and that the time left before playing back is superior to the threshold, then no video or audio data is modified in the buffer and the next video frame will be played. To the contrary, if the time left is inferior the threshold, another test is performed: if the time left is inferior to the threshold divided by 2, the video replay speed is also divided by 2 (this is achieved by replaying the current frame, once); if it is superior to the threshold divided by 2, the video replay speed is divided by 4 (this is achieved by replaying the video frame three times). It is observed that replaying a frame and adding a copy of the frame have the same signification.

At last, the same observations (nature of frames, distribution, visual impact, bitrate, etc) can be made for the opposite operation, wherein frames are deleted or omitted. It is again underlined that deleted frames are not necessarily those that were previously inserted.

FIG. 8 shows the detection of audio silence periods.

As shown in FIG. 8, there is provided:

a data flow (400);

non-silent audio periods (402) and (800); and

audio silence periods (404) and (810).

For the sake of clarity, another representation is used, showing the classic audio spectrum. Correspondence with previously used drawings is indicated.

Audio silences periods are obviously relative and dependent from measurement possibilities. One has to decide what is considered to be an audio silence period. Detecting audio silence periods thus refers to the usual way used by the skilled person to determine the silences. This can be achieved by several known methods, the more simple solution being characterized in that a threshold is chosen; audio sequences under the threshold will be considered as audio silences. The threshold can be in decibels (dB), in Watts, etc.

As shown with respect to FIG. 8, a data flow (400) is analyzed: a period (800) with a value lower than a predetermined threshold is considered to be an audio silence period (404 or 810). Thus, before the analysis at step (a), the data flow (400) comprises unanalyzed audio data and after the analysis at step (b) the data flow comprises an audio silence period (404) and the remaining data is still considered non-silent audio periods (402).

It is interesting to use a threshold with a high value (compared to the peak or the average value of the audio signal for example) because it will imply that a large number of audio sequences will be considered as audio silences, and that in consequence, there will be more possibilities to gain time for the retrieval of synchronized flows. To the contrary, if relatively few silence periods are decided, there will be fewer opportunities to use the described mechanism of the present invention.

It is observed that the use of a splitter may be necessary for the implementation of the invention. For example, in MPEG2 or MPEG4 data flows (streams), audio and video data are embedded in the same stream. In order to be able to detect or determine audio silence periods, it may then be necessary to separate audio data from video data.

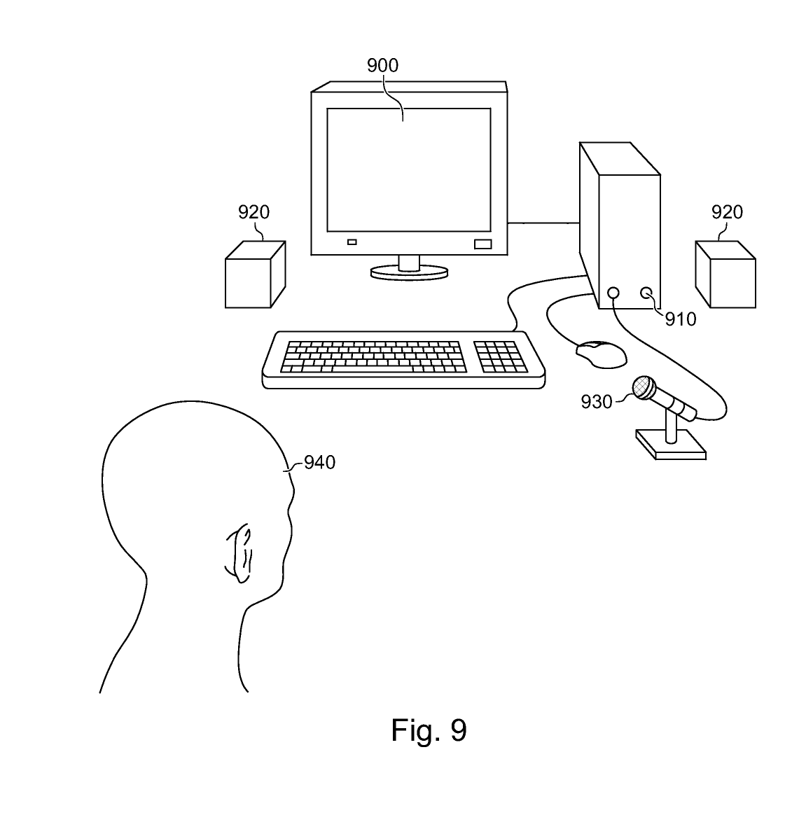

FIG. 9 shows measurements aspects for the audio silence periods detection.

As shown in FIG. 9, there is provided:

a computer comprising a central unit with a sound card, a screen display, a keyboard and a pointing device, with:

a display of the media player application (900);

an audio plug output (910);

audio speakers (920);

a microphone audio input (930); and

a user (940).

The central unit of a computer runs the media player application (160), which is displayed on a screen (900). An audio card delivers an audio signal to a plug (910). Alternatively, the audio card is connected to audio speakers (920); a microphone (930) is also connected to the audio card. A user (940) is listening audio or watching videos.

It is observed that FIG. 9 only shows one example of implementation, with a desktop personal computer. Embodiments can easily apply or be adapted to other hi-tech devices such as mobile phones, handheld organizers, personal digital assistants (PDA), “palmtop” devices, laptops, smartphones, multimedia players, TV set-top-boxes, gaming hardware, wearable computers, etc. All means comprising sound restitution (any type of headphones or speakers) and/or visual display (LCD, oled, laser retina displays, etc) can implement the present invention.

The present invention decides how and where to measure audio levels for detecting audio silence periods. Many audio levels can indeed be considered. A very first possibility is to measure the audio level that the user perceives in reality (the ideal solution would be a measure at ears of the user (940)). An even better solution would consist in taking into account his audition capabilities. Corresponding level can be measured with a microphone (930), as close as possible from the ears of the user (940). A second possibility is to measure audio level at the audio speakers (920). A third solution is to take as reference at the audio plug output (910). A fourth solution is to retrieve the audio level directly from the media player application (900) itself (it is a more convenient solution because related values can be easily accessible in software data); this solution makes abstraction of the audio system connected to the computer.

It is observed that the audio level can be measured, but also simulated or predicted. Further developments may enable predictions of the acoustic environment to be taken into account (so as measures of the ambient noise and psycho-acoustics parameters).

Measures and analysis of the user's audio environment, performed by the microphone (930), ideally located near the user's ears, can thus help deciding the best periods for modifying data (taking the risk that the data will be interpreted and played back if necessary data aren't received). It is observed that the microphone has a specific importance: it is known that there is no way for evaluating the real audio environment of a user without performing real audio measures or feedbacks. DRM or Digital Rights Management refers to this point under the specific vocabulary of “analog hole” to underline that the analog signal (speakers, user) can not be taken into account or controlled (the chain has to be fully digital to be properly controlled, like HDMI). One can indeed imagine a series of particular scenarios: if the speakers are turned off, it can be considered that the entire data flow is silent. The same conclusion comes out if the speakers' sound level is so low that the user can't hear it.

In another embodiment, the present invention discloses a method for buffering in a media player synchronized rich media components by slowing down the video playback during audio silences of a first rich media component until a second required and synchronized rich media component is retrieved; and by speeding up the video playback during the audio silences when the second component is retrieved.

In a further embodiment, the invention relates to synchronizing data flows, for example adjacent document frames with an audio/video stream. Metadata indicating the moments at which a new frame should be displayed are inserted in the audio/video stream. The stream is buffered at a receiver, and the buffer contents are scanned for metadata. Where metadata are found indicating a slide which has not yet arrived, the system enters a stalling phase during which the length of any silent periods in the audio/video stream are stretched. As the point in the audio/video stream at which the missing slide gets closer, the factor by which silent periods are stretched increases exponentially (i.e., video stream is slowed down by adding duplicated video frames during audio silence periods). Once the expected slide in fact arrives, playback of the audio/video stream is speeded up by compressing silent periods (i.e., video stream is speeded up by skipping video frames during audio silence periods) so as to clear the backlog of audio/video data that built up in the buffer during the stalling phase. In other words, the invention describes how to slow down or fasten the playing of video without perceptible alteration of audio while retrieving other media elements of the rich media file.

In another embodiment, the invention relates to the synchronization of two data flows, by extending or compressing periods of silence in a first flow comprising audio data in order to accelerate or decelerate that flow to compensate for variations in the delivery rate of a second flow. The invention slows down or speeds up both video and audio flows or streams during audio silences.

In a further embodiment, the first data flow is buffered at a receiver and the buffer contents are scanned for metadata. Where metadata are found indicating a second data flow which has not yet arrived, the system enters a stalling phase during which the length of any silent periods in the first data flow are stretched. As the point in the first data flow at which the second data flow is necessary gets closer, the factor by which silent periods are stretched increases exponentially. Once the expected second data flow in fact arrives, playback of two data flows is accelerated by compressing silent periods so as to clear the backlog of additional data that built up in the buffer during the stalling phase.

1. A method for synchronizing data flows, comprising:
receiving a first data flow, the first data flow comprising audio data;
receiving a synchronization mark, the synchronization mark associating first data of the first data flow with second data of a second data flow;
detecting at least one audio silence period in the first data flow; and
increasing a duration of the at least one audio silence period when the synchronization mark is received before receipt of the second data of the second data flow.

2. The method of claim 1, further comprising:
decreasing the duration of the at least one audio silence period.

3. The method of claim 1, wherein the first data flow comprises a plurality of audio silence periods and wherein the duration of a lastly received audio silence period is increased until the second data of the second data flow is received.

4. The method of claim 1, wherein the duration of the at least one audio silence period is increased until the second data of the second data flow is received.

5. The method of claim 1, wherein the duration of the at least one the audio silence period is increased until a time-out period expires.

6. The method of claim 1, wherein the first data flow is an audio/video data flow.

7. The method of claim 6, further comprising:
inserting video data.

8. The method of claim 6, further comprising:
omitting video data.

9. The method of claim 7, wherein the inserted video data are duplicated or interpolated frames.

10. The method of claim 1, wherein the audio silence periods are human or artificial voice audio silences.

11. The method of claim 1, wherein the audio silence periods are detected according to the audio environment of a user of a buffer, the environment being determined or simulated by software data or measured by using a microphone.

12. An apparatus for synchronizing data flows, comprising:
a system for receiving a first data flow, the first data flow comprising audio data;
a system for receiving a synchronization mark, the synchronization mark associating first data of the first data flow with second data of a second data flow;
a system for detecting at least one audio silence period in the first data flow; and
a system for increasing a duration of the at least one audio silence period when the synchronization mark is received before receipt of the second data of the second data flow.

13. The apparatus of claim 12, further comprising:
a buffer;
wherein the first data flow is received by the buffer, wherein the at least one audio silence period is detected in the first data flow received in the buffer, and wherein the duration of the at least one audio silence period is increased when the synchronization mark is received before receipt of the second data of the second data flow is implemented in the buffer.

14. The apparatus of claim 13, further comprising:
a network controller, the network controller measuring network delays and controlling the increase or the decrease of the duration of the audio silence period or periods.

15. A computer program loaded on a computer readable medium, comprising instructions for synchronizing data flows when the computer program is executed on a computer, comprising instructions for:
receiving a first data flow, the first data flow comprising audio data;
receiving a synchronization mark, the synchronization mark associating first data of the first data flow with second data of a second data flow;
detecting at least one audio silence period in the first data flow; and
increasing a duration of the at least one audio silence period when the synchronization mark is received before receipt of the second data of the second data flow.
